(19) United States
(12) Patent Application Publication
(10) Pub. No.: US 2006/0153965 A1
(43) Pub. Date: Jul. 13, 2006

(54) Edible legume products

(76) Inventors: Cheryl K. Borders, Moweaqua, IL (US); Michael J. Fleckenstein, Decatur, IL (US); Thomas V. Gottemoller, Mt. Zion, IL (US); Christopher A. Sandberg, Oreana, IL (US); Clifford A. Strickland, Saginaw, TX (US)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(21) Appl. No.: 11/280,551

(22) Filed: Nov. 16, 2005

Related U.S. Application Data
(63) Continuation-in-part of application No. 10/998,435, filed on Nov. 29, 2004.
Application No. 10/998,435 is a division of application No. 10/040,942, filed on Jan. 9, 2002, now abandoned.
(60) Provisional application No. 60/263,529, filed on Jan. 24, 2001.

(51) Int. Cl. A23L 1/20

(52) U.S. Cl. 426/634

(57) ABSTRACT

This invention is directed to processes for producing legume products, and the legume products resulting therefrom.

### CROSS REFERENCE TO RELATED APPLICATIONS

This application claims priority as a continuation-in-part to pending U.S. patent application Ser. No. 10/998,435, filed Nov. 29, 2004, published as US Pub. No. 2005/0095346 on May 5, 2005, which itself claims priority as a divisional of U.S. patent application Ser. No. 10/040,942, filed Jan. 9, 2002, which claims priority to U.S. Provisional Patent Application 60/263,529, filed Jan. 24, 2001, each of the contents of the entirety of which are incorporated by this reference.

### TECHNICAL FIELD

The invention relates to the art of food preparation and more particularly, to edible bean products.

### BACKGROUND

Some methods of making dried whole beans, bean flakes and bean powders which are reconstitutable do exist. Generally, these known methods consist of combinations of the following steps: soaking, blanching, parboiling, physical manipulations prior to cooking, cooking under pressure or at atmospheric pressure, post-cooking manipulations and various methods of drying the cooked product. If the desired final product is dehydrated, cooked whole beans, the prior art discloses that the beans are soaked or blanched without pre-cooking. The prior art discloses that the reconstitution of dried commutated and/or powder product occurs in a few minutes upon the addition of hot water, while the reconstitution of dehydrated, cooked whole beans occurs in approximately 15-30 minutes. Both batch and continuous process are disclosed in the prior art for making dried leguminous products. Other prior art processes are variations on the above mentioned general processes. For example, U.S. Pat. No. 4,676,990 produces a mash of legume material and forms the mash into shapes. U.S. Pat. No. 5,863,592 uses a specific numbers of rollers to flake the legume product. U.S. Pat. Nos. 5,902,629 and 5,213,831 pre-cook the beans using infrared energy. U.S. Pat. No. 5,916,624 is drawn to methods of flash freezing legume products. A milling step is performed in the process of U.S. Pat. No. 5,980,971. Prior to processing, whole beans are cracked in the process of WO 98/15190.

Problems encountered by the prior art methods include the requirement of large production areas to soak and cook the beans, long time periods for soaking and cooking the beans, lack of adequate controls over the cooking process leading to over or under cooking, batch to batch variability and a product that does not closely resemble the conventionally prepared product. The manipulation of the beans during these processes can lead to the product being inferior due to damage incurred during the handling of the beans. In addition, the reconstitution of the dried product often takes longer than a few minutes, even when hot water is used. Moreover, powders produced by these methods tend to produce a lumpy product after rehydration.

The lack of suitable legume products fails to address the nutritional needs of the population. For instance, in the United States, there is increasing concern over the consumption of high sugar and high fat foods by the population. In fact, in 2005, the US government revised the Dietary Guidelines for food consumption in the United States. One of the goals of the revision of the Dietary Guidelines is to stop the alarming increase in obesity among the youth in the United States as too many children are overweight due to a lack of exercise and poor eating habits. One problem in children's diets is that if the school aged children do not care for the food being offered at school cafeterias, the children are able to obtain a foodstuff such as a candy bar, or other high sugar or high fat snack out of a vending machine located at the school. Thus, some children's diets may become focused on high sugar or high fat foodstuffs.

In the 2005 Dietary Guidelines Pyramid, beans and peas are listed under both the Vegetables and, the Meats and Beans categories, thus, emphasizing the healthy nature of legumes in the diet. As a further sign of a growing emphasis in the United States on healthier diets and the problem of obesity in the US population, California has passed legislation mandating that healthier snacks be provided to children at vending machines in schools in an attempt to limit the sugar and fat consumed by the children.

In addition to the emphasis on lower fat and lower sugar diets, beneficial effects of legumes are becoming increasingly apparent. For instance, inositol polyphosphates, which are naturally occurring substances found in most legumes, have been implicated in being able to inhibit the growth of some cancer xenografts. (See, Cancer Resources, 2005; 65: (18), Sep. 15, 2005). Thus, the benefits of healthy diets including legumes are gaining recognition in the United States.

The danger of high sugar or high fat diets in children is also being seen outside of the United States. For instance, in Great Britain, the British government has taken proactive measures to deal with the issue of childhood obesity by regulating food in school cafeterias and vending machines located at schools. Junk foods high in fat, salt or sugar will be banned from school cafeterias and vending machines will only be allowed to provide healthy fares. Government officials in Canada are also addressing the rapid rise in childhood obesity and are looking at limiting the sale of chocolate bars, other candy and pop in elementary school vending machines.

With the passage of laws and regulations requiring healthier foods and snacks be provided in schools, as well as an increased awareness of the health benefits of legumes, there exists a need for healthier food products and foodstuffs that provide the beneficial nutritional effects of legumes.

As such, there is a continuing need in the art to provide food products containing the healthy effects of leguminous products and that are quick and easy to prepare.

### SUMMARY OF THE INVENTION

In one embodiment, a composition comprising a legume product is disclosed. The legume product has an increased amount of dietary fiber on a dry weight basis as compared to a raw legume from which the legume product originates.

In another embodiment, a legume containing product is produced by a process. The process includes blanching legumes or legume products, cooking the legumes or legume products, and dehydrating the legumes or legume products. In an additional embodiment, an organic acid used to blanch the legumes or legume products, cook the legumes or legume products, or to blanch and cook the legumes or legume products.

In yet a further embodiment, a bean product having an increased amount of dietary fiber on a dry weight basis as compared to a raw bean from which the bean product originates is disclosed.

### BRIEF DESCRIPTION OF THE DRAWINGS

FIG. 1 is a diagram of one embodiment of a cooker/decompression loop employed in the process of preparing reconstitutable bean products of the present invention.

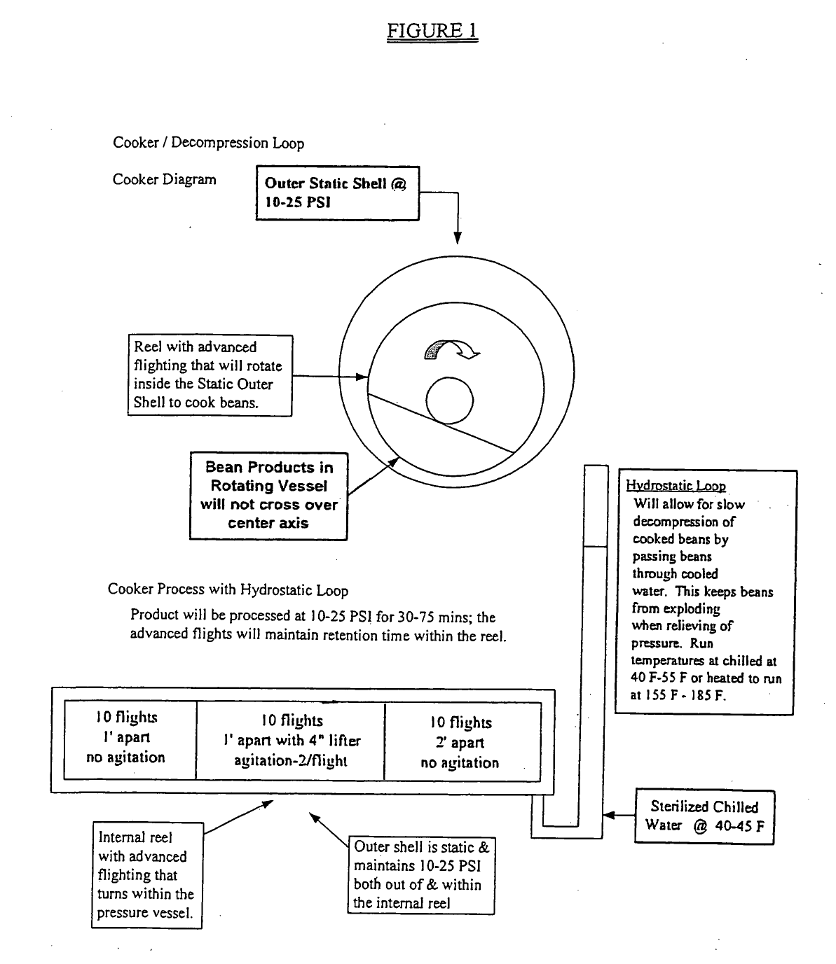

FIG. 2 is one embodiment of a flow chart illustrating a sequence of operations performed in the practice of the invention.

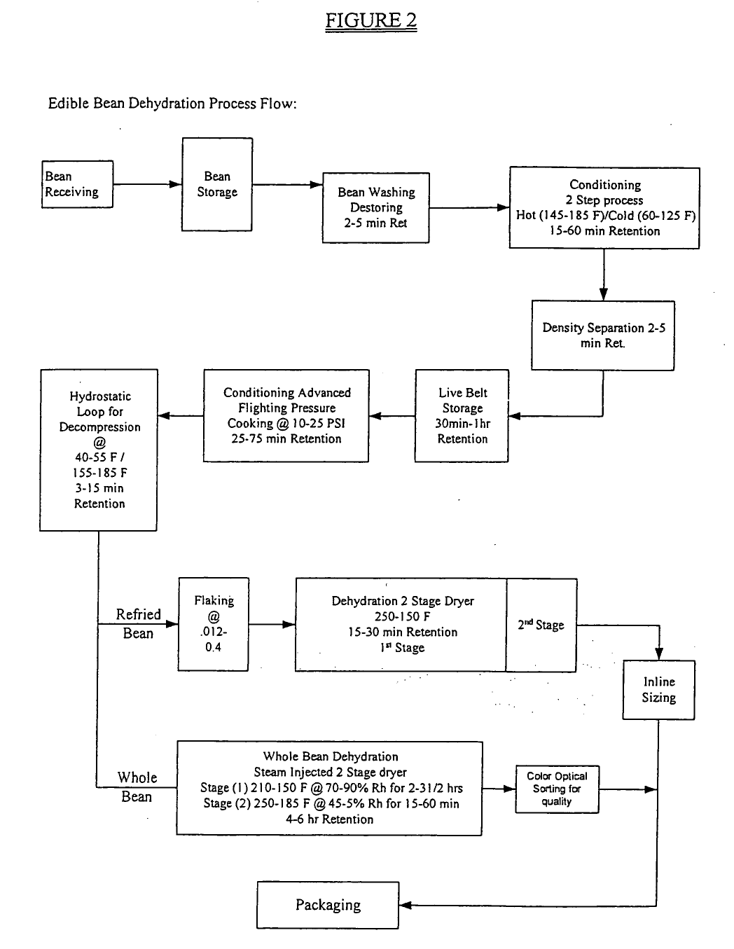

### DETAILED DESCRIPTION OF THE INVENTION

In one embodiment, a process for making dehydrated, instantly reconstitutable, leguminous food products having the characteristic flavor, texture and color of conventionally prepared legumes is disclosed. In another embodiment, a process for producing reconstitutable legume products comprising conditioning the legumes by subjecting the legumes to hydration; cooking the legumes in a continuous advanced flight pressure vessel; depressurizing the cooked legumes in a hydrostatic loop; and dehydrating the legumes to form a reconstitutable legume product.

Another embodiment is drawn to a process for producing reconstitutable legume products comprising continuous conditioning of the legumes by subjecting the legumes to hydration; cooking the legumes in a continuous advanced flight pressure vessel; depressurizing the cooked legumes in a chilled or hot hydrostatic loop; and dehydrating the legumes to form a reconstitutable legume product.

In another embodiment, a continuous advanced flight rotary drum blancher for conditioning the legumes and a continuous advanced flight pressure vessel are used in the preparation of reconstitutable legume products. The advanced flight mechanisms ensure that the product is advanced continuously through the conditioning and cooking steps without subjecting the legumes to handling procedures that could shear or crush the legumes.

The process further comprises washing and destoning raw legumes; carrying out the hydration in a continuous advanced flight rotary drum blancher in one, two or multiple stages; cooking the legumes in a continuous advanced flight pressure vessel; depressurizing the cooked legumes in a hydrostatic loop; and dehydrating the legumes in a one, two or multiple stage drying process to form a reconstitutable legume product. An organic acid may also be incorporated into the hydration/blanching step and/or the cooking step of this process.

In a further embodiment, a method for producing a commutated bean product and/or a whole bean product is disclosed. The resulting products are particularly well suited for making food stuffs including refried bean products.

It yet an additional embodiment, a method for producing instant or quick cook soups or stews which incorporate reconstitutable whole or intact legume products or powders is disclosed. Snack foods, which incorporate reconstitutable legume products or powders may also be prepared.

In a further embodiment, a method for producing reconstitutable legume products includes: blanching legumes in water for a period of time; tempering the blanched legumes for a period of time; cooking the tempered legumes in water for a period of time; and dehydrating the cooked legumes to form a reconstitutable legume product; wherein an organic acid may be added to the blanching water, to the cooking water, or to both.

Another embodiment discloses a process for producing reconstitutable legume products comprising: blanching legumes in water for a period of time; tempering the blanched legumes for a period of time; cooking the tempered legumes in water for a period of time in the presence of an organic acid; and dehydrating the cooked legumes to form a reconstitutable legume product.

In a further embodiment, a continuous process for producing a dry, commutated, instantly reconstitutable Mexican refried bean product or an intact whole legume instantly reconstitutable for soups or side dishes is disclosed. The invention is an advance in the technology for producing rehydratable bean products because the method eliminates the steps of soaking and pre-cooking the beans to prepare foods from raw, whole legumes. The reconsitutable products also reduce the cooking time and consistently results in a dried product that is truly reconstitutable to a product with the desired characteristics of Mexican-style refried beans. In addition, other snack foods and food products may be produced. The invention also discloses a dehydrated bean product with higher nutritional quality (i.e., having a higher dietary fiber content than raw legumes) and appearance than conventional dehydrated beans.

Many dehydrated beans on the market have many splits and broken pieces and when cooked, have a significant amount of loose skins and free meats showing, as well as being darker than canned or dry bag beans. The beans produced by the methods disclosed herein are easy to prepare and provide the same yield of finished beans as dry bag beans. The beans also have significantly fewer loose skins and free meats than the current dehydrated beans on the market as well as have color similar to canned or dry bag beans.

Refried beans are popular as a side dish used in Mexican-style cooking. Mexican-style foods have become one of the fastest growing segments in the American food market, both for home use and in food institutions. Additionally, quick prep soups, meals and side dishes using other various legume and pulse products such as, for example, red beans, navy beans, pinto beans, great northern beans, kidney beans, lima beans, peas and chickpeas are becoming more popular. These legumes are a great source of fiber and have a sugar profile with pro-biotic properties. Further, given today's lifestyles, meals may be prepared quickly, often in 35 minutes or less. When preparing raw, whole legumes, they need to be prepared from scratch in a process that involves several steps. These steps include soaking the beans for several hours or even overnight, cooking the beans in a kettle for several more hours and mashing the cooked beans. The cook usually prepares a large batch, which is then refrigerated and refried by heating a portion of the batch to serve at each meal. Therefore, traditional dry bag beans do not meet the needs of those who prepare meals today.

Since the process of preparing raw, whole legumes is time consuming, expensive and labor intensive, canned refried beans have become popular for home use. However, canned beans are expensive and inefficient to use in the preparation of refried beans for institutional and restaurants use where large quantities of a product with consistent characteristics are desired. Even in domestic households, canned beans, while providing the heat and serve convenience, are heavy to carry and difficult to dispose of and therefore less likely to be used.

Restaurant-sized cans of beans are heavy, expensive to ship, require large storage areas, and are inconvenient to use in the preparation of large quantities of refried beans. For instance, restaurant cooks must open many cans to prepare large servings. Disposal of the resulting empty cans is also a problem for restaurants because, in some states, the law requires cans to be washed before disposal. In addition, leftover products may create a food safety issue for the public. Therefore, dehydrated beans or legumes packed in bags are useful for restaurants and institutional use. Not only is shipping and storage easier and less expensive for the dehydrated beans or legumes, but also the preparation is simpler and usually involves adding hot water and serving. In addition, the cost per serving for dehydrated bean products or legumes is less than that of canned beans. These factors have led to a growing demand for dehydrated refried bean products as well as other dehydrated legume products for institutional, retail, restaurant, and private volunteer organization food preparation

Further, reconstitutable legume products such as instant or quick prep soups, side dishes, complete meals and snack foods which incorporate legumes and pulse products may also be prepared from dehydrated products.

In a further embodiment, a dehydrated legume, a dehydrated legume flour, a dehydrated legume powder or a dehydrated legume product, or a foodstuff comprising the a dehydrated legume, a dehydrated legume flour, a dehydrated legume powder or a dehydrated legume product, produced with the methods described herein have an increased dietary fiber percentage on a weight basis as compared to a non-dehydrated or raw legume, flour, powder or product or foodstuff containing the same. For example, dehydrated Pinto beans comprise about 27% dietary fiber, while non-dehydrated or raw Pinto beans comprise about 12% dietary fiber; dehydrated Small Red beans comprise about 23% dietary fiber, while non-dehydrated or raw Small Red beans comprise about 8.9% dietary fiber; dehydrated Black beans comprise about 29% dietary fiber, while non-dehydrated or raw Black beans comprise about 13.3% dietary fiber; dehydrated Navy beans comprise about 23% dietary fiber, while non-dehydrated or raw Navy beans comprise about 9.8% dietary fiber; dehydrated Dark Red Kidney beans comprise about 24% dietary fiber, while non-dehydrated or raw Light Red Kidney beans comprise about 10.6% dietary fiber; and dehydrated Light Red Kidney beans comprise about 24% dietary fiber, while non-dehydrated or raw Light Red Kidney beans comprise about 10.6% dietary fiber.

In another embodiment, a dehydrated legume or legume product produced using the methods disclosed herein is subjected to a milling process to produce a legume powder, flour or product. In one embodiment, the dehydrated legume or legume product may be subjected to a form of crushing or pulverizing such as by passage of the dehydrated legume or legume product through a hammermill or universal mill. In one embodiment, the dehydrated legume or legume product is ground in a PC-20 mill. The ground or powdered dehydrated legume or legume product may also be passed through a swecoscreen 60 mesh, wherein the ground or powdered dehydrated legume or legume product has a particle size of less than about 0.250 mm. The ground or powdered dehydrated legume or legume product may further be passed by a magnet to remove any metallic (i.e., iron-containing) contaminants, and further be placed in containers for shipping or placed in a food product. The containers may include, without limitation, bags, boxes, plastic containers, totes, or cans.

The processes described herein may be used to produce a reconstitutable legume product for use in a ready-to-eat food product. Although legumes are typically thought to be Phaseolus species, or beans, many other varieties may be used to form such a legume product. For example, species of green and yellow peas (Pisum), lentils (e.g. Lens vulgaris) and peanuts may be processed in addition to beans. Other legume genuses and varieties are also useful for processing. For example, Cicera arietenum (chickpeas), Glycine max (soybeans), Arachis hypogaea (peanuts) and trefoil (Lotus corniculatus) may be processed by the methods described herein. Phaseolus, or bean, varieties that may be processed include pinto beans, Great Northern beans, navy beans, red beans, black beans, dark and light red kidney beans, fava beans, green baby lima beans, pink beans, myasi beans, black eyed beans, garbanzo beans, cranberry beans, white beans, rice beans and butter beans.

The use of organic acids or their salts during the processing of dehydrated legumes and/or pulses described herein enables the production of dehydrated legumes and/or pulses that are similar in color, texture and appearance to legumes and/or pulses prepared under traditional methods, such as canned beans or preparations from dry bag beans.

The legumes and/or pulses may be harvested, cleaned, sorted, dried and put into storage until ready for further processing. At this time the legumes or pulses are resorted and washed to remove stones or loose dirt.

The legumes and/or pulses may be blanched at a temperature of about 50° C. to about 100° C., or between about 60° C. to about 85° C. The blanching may take place for a time period of about 10 minutes to about 50 minutes, about 10 minutes to about 40 minutes, or from about 20 minutes to about 40 minutes. The temperature of the blanch water may be varied over time to achieve the desired finished texture of the product.

An organic acid or its salt may also be added to the blanch water, the cook water, or both, at an amount ranging between about 0.1% to about 5% or about 0.2% to about 3%. The organic acids that may be employed at this stage, or at the cooking stage, or at both stages, include one or more of acetic acid, citric acid, gluconic acid, gluconolactonic acid, lactic acid, ascorbic acid, malic acid their salts, and mixtures of any thereof.

In another embodiment, calcium chloride may be added to the blanch water at about 0.1% to about 1% of volume of the water or about 0.2% to about 0.7%. The amount of calcium chloride added may also be based on the dry weight of the legumes or pulses, wherein about 0.5% to about 10% calcium chloride may be added to the blanch water, or about 1% to about 5% calcium chloride may be used. The legumes and/or pulses may be tempered for about 10 minutes to about 90 minutes, or about 20 minutes to about 45 minutes.

In an additional embodiment, tempering may be performed at the as-is temperature when the product removed from the blanching process.

The legumes and/or pulses may be cooked in water at a temperature of between about 100° C. to about 125° C. or between about 105° C. to about 120° C. for about 10 minutes to about 60 minutes, about 10 minutes to about 45 minutes, or between about 20 minutes to about 45 minutes.

The organic acids may also be added at the cooking stage in the same amounts as described herein. The organic acid or its salt may be added to the cook water at between 0.2% and 3%. The organic acids that may be added at the cooking step include one or more of acetic acid, citric acid, gluconic acid, gluconolactonic acid, lactic acid, ascorbic acid, malic acid their salts and mixtures thereof. Sugar, glycerine and/or sorbitol may also be added to the cook water at an amount between about 0.5% and about 10%, based on the weight of the dry legumes and/or pulses. The sugar, glycerine and/or sorbitol may be added at an amount between about 2% to about 10%, or from about 2% to about 6%.

Salt may also be added to the cook water at between about 0.1% to about 10%, based upon the dry weight of the legumes and/or pulses, or in another embodiment between about 0.1% and about 5%.

The legumes or pulses may be removed from the cooker and dried under conditions practiced in the industry, as described herein. The organic acids added at either or both of the blanching and cooking steps help to maintain the nutritional qualities of the legumes and pulses by not allowing complete denaturation of proteins and sugars encapsulated within the seed coat. Therefore, soluble product losses are minimized. The addition of the organic acid also reduces the discoloration of the finished legumes or pulses after drying and preparation, as well as prevents the skins from cracking and disassociating from the product.

The invention is further drawn to a process for producing reconstitutable legume products comprising conditioning the legumes by subjecting the legumes to hydration; cooking the legumes in a continuous advanced flight pressure vessel; depressurizing the cooked legumes in a hydrostatic loop, and dehydrating the legumes to form a reconstitutable legume product.

The invention is further drawn to a process for producing reconstitutable legume products comprising continuously conditioning the legumes by subjecting the legumes to continuous advanced flight hydration; cooking the legumes in a continuous advanced flight pressure vessel; depressurizing the cooked legumes in a chilled or hot hydrostatic loop; and dehydrating the legumes to form a reconstitutable legume product.

In yet another embodiment, the raw legumes may be washed and destoned. This step may be performed for a period of about 1 to about 10 minutes, about 1 minute to about 5 minutes, or from about 2 minutes to about 4 minutes. The legumes may be immersed in water so that chaff, sticks and pod material are floated off and dirt and stones are removed through a series of riffles. Legumes of lower quality may also be removed.

Following washing and destoning, the legumes are conditioned. This can be a one, two or multiple stage process. Conditioning in hot or cold water may modify flavor and/or color. Additionally, process additives, such as calcium chloride or sodium hexameta-phosphate, can be added to enhance processing. In one embodiment, the legumes are conditioned by hydration in a two-stage process. This process may take place in an advanced flight rotary drum blancher as a continuous process. If multiple stages of conditioning are used, the legumes are moved from one stage to the next as the legumes are moved through the rotary drum. In one process, the legumes are immersed in water during the first stage of conditioning. The legumes may be moved through the water by the advanced flighting with modified blanching temperatures.

The conditioning process may be a two-step hydration process which may take place in a continuous advanced flight blancher. In a heated water process, the legumes are immersed in water and/or heated to about 100° F. to about 215° F., from about 110° F. to about 210° F., or from about 120° F. to about 165° F. The legumes may also be subjected for a second period of time to water at a higher temperature of about 125° F. to about 225° F., about 130° F. to about 210° F., or from about 145° F. to about 200° F. The conditioning process can also take place in cold water which fixes product colors.

In a cold water conditioning process, the legumes are immersed in water at about 35° F. to about 100° F., about 40° F. to about 95° F., or from about 450° F. to about 85° F. The legumes may also be subjected for a second period of time to water at a higher temperature of about 40° F. to about 145° F., about 50° F. to about 135° F., or from about 55° F. to about 125° F.

The conditioning process may take about 5 minutes to about 3 hours, about 10 minutes to about 2 hours, or about 15 minutes to about 60 minutes, in the case of high temperature conditioning. With cold water conditioning, this process can take from about 30 minutes to about 4 hours, or about 1 hour to about 3 hours. During conditioning, the legumes are hydrated and evenly blanched due to the continuous advanced flighting process.

Any remaining stones and low quality legumes may be removed by density separation methods which will remove any low quality beans and stones that were not removed during a washing/destoning step. Only high quality legumes remain to be formed into the reconstitutable legume product. The density separation takes about 1 to about 20 minutes, about 1 to about 10 minutes, or about 1 to about 3 minutes.

After the density separation, the legumes are optionally subject to live belt storage, or tempering, in order to stabilize the moisture within the legumes. After tempering, the products may be conveyed through an open channel air lock into an advanced flight pressure vessel where the legumes are cooked. The tempering takes place for a period of about 10 minutes to about 3 hours, about 20 minutes to about to about 2 hours, or about 30 minutes to about 1 hour.

The cooking step is performed using a continuous advanced flight pressure vessel where further processing additives can be added, such as salt, organic acids or their salts and/or sugar, along with other types of processing agents. This may include a rotating advanced flighted reel within a static outer shell. The flighted reel rotates within the static outer shell on a set of trunions under pressure to cook the beans from about 10 minutes to about 2 hours, about 15 to about 90 minutes, or about 25 to about 75 minutes at a temperature of about 200° F. to about 300° F., about 230° F. to about 285° F., or about 245° F. to about 255° F. The cooker comprises several sets of flights through which the legumes are continuously moved during cooking. There are three sets of ten flights, the first and third are without agitation with the middle set of flights having subtle agitation lifters within the flights rolling the product gently. An internal reel with flighting moves the legumes continuously through the cooker as it turns therefore being able to control the retention within the processing reel. As the product moves through the reel, the product continues to gain mass, therefore, the last set of flights may be spaced farther apart to eliminate the shearing effects of added weight.

The outer shell is static and maintains the pressure from about 10 PSI to about 25 PSI both within and outside of the internal reel. The pressure may be maintained at about 11 PSI to about 20 PSI, or from about 12 PSI to about 17 PSI. Since the legumes are moved continuously through the cooker, there is no chance for the legumes to be in contact with mixing blades or to fall back upon the mixture during the final stages of cooking. This prevents the shearing and crushing of the legume product as it is moved continuously through the cooker. The cooking time can be controlled through the speed of the advanced flighting rotation through the cooker.

After cooking, the legume products may be conveyed continuously into the decompression bucket leg, or hydrostatic loop. This decompression leg may be used to maintain the pressure within the pressure vessel by providing a head of chilled or hot water. At this time, the legumes are depressurized through a water column to keep the legume intact and allowing the legume product to stabilize thermodynamically. The legumes enter the hydrostatic loop and are passed through sterilized chilled or hot water for about 1 to about 15 minutes, about 1 to about 10 minutes, or about 2 to about 8 minutes. The legumes rise through the water and undergo a slow decompression. The temperature at which chilled decompression may take place is about 35° F. to about 75° F., about 40° F. to about 70° F., or about 45° F. to about 65° F. Hot water decompression may take place at a temperature of about 130° F. to about 215° F., about 145° F. to about 200° F., or at about 165° F. to about 185° F. Alternatively, the chilled decompression may take place at about 30° F. to about 55° F., about 35° F. to about 45° F., or from about 35° F. to about 40° F. Decompression at lower temperatures enables the thermal activity to be stopped with the chilled water, which aids in slow decompression. Slow decompression of the legumes helps avoid puffing or exploding of the legumes since normal depressurization of legume products tends to puff or explode the legumes. Following the decompression, one of two routes of processing may be performed. If a whole legume product is produced, the product is let down to a tunnel type dryer by a soft drop spiral which bypasses the flaker rolls so as not to damage the product prior to drying. The cooked, intact legumes may be subjected to steam injected or atomized water at low temperature in order to maintain a high relative humidity during the drying process. The drying process for whole bean products may take place in one, two or multiple stages and involves the use of unidirectional airflow up through the product at moderate temperatures with high humidity utilizing long term drying. The entire drying process may last from about 1 to about 5 hours. The drying temperature may drop throughout the range over the drying period.

If a commutated, flaked, ribbon form, or powdered legume product is desired, the cooked legumes may be subjected to a form of commutating either by Fitzmill, Comitrol, Flaking, and/or blending by passing the legumes through prior to drying. One set of flaking rolls may be used. The drying process for the commutated bean products may take place in one, two or multiple stages and involve the use of bi-directional airflow at moderate temperatures utilizing long term drying. The entire drying process can last from about 5 minutes to about 60 minutes. The drying temperature may drop throughout the range over the drying period. The flaked or ribbon form of the legume product may be produced by mashing or macerating the legumes with a macerating pump and forming the legume product into the flaked or ribbon form by passing through a die.

In yet a further embodiment, whole, intact legumes may be subjected to a drying process which includes a two-stage process using unidirectional airflow up through the product. A first stage drying may be performed at about 50% to about 95% Rh or about 70% to about 90% Rh directed up through the product bed avoiding direct air from above the product for about 1 hour to about 5 hours, about 1.5 hours to about to about 4 hours, or about 2 hours to about 3.5 hours, while the temperature is maintained between about 1250° F. to about 250° F., about 150° F. to about 210° F., or from about 165° F. to about 190° F. A second stage of drying may be performed at temperatures from about 150° F. to about 300° F., about 175° F. to about 265° F., about 185° F. to about 250° F., at about 35% to about 60% Rh, about 45% to about 50% Rh for about 5 minutes to about 90 minutes, about 15 minutes to about 85 minutes, or about 45 minutes to about 75 minutes. The dehydrated whole legume product may be subjected to color optical sorting and packaging. By use of color cameras, a computerized grid is formed and used to select intact product from the inherent broken pieces produced through material handling. The broken pieces are removed from the product stream by multiple air rejecters located above the product stream.

In one embodiment, the legumes can be commutated prior to drying through several means such as, for example, Fitzmill, Comitrol, Pumping, blending and/or flaking. The pumping may comprise macerating the legumes within a progressive cavity pump having a series of knives attached to a feed auger assembly that shears the legumes into a mash for pumping onto a drying bed. In one embodiment, one set of flaking rolls are placed so that a gap of about 0.004 inches to about 0.25 inches, about 0.010 inches to about 0.10 inches, or about 0.012 inches to about 0.030 inches allows for quick preparation. The size of the flaker gap will determine the rate of reconstitution as well as the texture of the product. The texture and the reconstitution time are determined by the consumer's needs. Following flaking, the legumes are subject to an indirect steam heated two-to-three stage dryer with multiple zones using bi-directional airflow through the product bed. By using a multiple stage dryer, a higher quality product can be produced. The process may be a two-stage process. Drying takes place initially at temperatures time from about 200° F. to about 300° F., about 215° F. to about 285° F., at a humidity level of about 0% to about 45% Rh, about 10% to about 40% Rh, or about 25% to about 35% Rh. The first stage may be followed by a second stage drying at temperatures from about 270° F. to about 150° F., about 160° F. to about 260° F. with the humidity in the second stage of about 0% to about 20% Rh, about 2% to about 15% Rh, or about 3% to about 10% Rh. The drying time for each stage is about 5 minutes to about 60 minutes, about 10 minutes to about 50 minutes, or about 15 minutes to about 30 minutes. The dehydrated legumes may be sized and/or sorted and packaged for use.

In yet an additional embodiment, the dehydrated legumes, dehydrated legume powders, dehydrated legume flours, or other dehydrated legume product may be produced at a first geographic location and transported or shipped to a second geographic location. For instance, a facility at the first geographic location may be able to produce a product more economically than a facility at the second location due to various factors. The factors may include, inter alia, lower costs of materials (i.e., the legumes themselves, pesticides used for legume production, fertilizers), lower costs of energy (i.e., electricity or gas), lower costs of labor (i.e., wages paid to employees), lower costs of environmental controls or effects (i.e., a drought may be present in one location or certain pesticides may be highly regulated in one location), or any other requirement for production. Further, a certain product may be well suited for production in the first geographic location and desired, but not produced well in the second geographic location. As a non-limiting example, residents of Alaska may desire bananas produced in Central America. Thus, the costs of producing the products in the first geographic location may be less than the costs of producing the products in the second geographic location resulting in the production costs of the product being less in the first geographic location.

In such an instance, the dehydrated legumes, dehydrated legume powders, dehydrated legume flours, or other dehydrated legume product may be produced at the first geographic location and shipped to the second geographic location such as by transport over water with ships or barges, trucking, flying, or other means of transportation. The geographic location may be a county, a state, a country, a continent and/or combinations of any thereof. In this manner, the product may be produced in a first country, and transported and/or sold in a second country.

A food product including the legume powder of flour produced with the methods described herein is prepared as follows. A food ingredient is mixed with a dehydrated legume powder, and the resulting mixture is blended together. The dehydrated legume powder may be in the form of a flake or a ribbon. A dough or batter is formed by blending the resulting mixture with an aqueous solution. The dough or batter may also be subjected to elevated heat such as, for example, by baking, frying, extruding, steaming, roasting, and combinations of any thereof to form the food product.

Non-limiting examples of food products that may be produced include, but are not limited to, bean dips, taco fillings, taco shells, burrito fillings, tortillas, nacho components, soup bases, soups, taco salad components, side dishes (i.e., refried beans), pasta, tortilla chips, chips, snack foods, milk, juice, soft drinks, other beverages, tortillas, bagels, bread, dough, re-fried beans, or any other food product.

The food ingredient may comprise a protein such as wheat protein, wheat protein isolate, wheat gluten, buttermilk solids, milk powders, egg protein, canola protein, pea protein, wheat protein, potato protein, corn protein, sesame protein, sunflower protein, cottonseed protein, copra protein, palm kernel protein, safflower protein, linseed protein, peanut protein, lupin protein, oat protein, soy protein, soy protein concentrates, soy protein isolates and mixtures of any thereof. In other embodiments, the food ingredient comprises a flour or a meal. Non-limiting examples of crops that may be used to produce the flour or meal in combination with the dehydrated legume powder include corn, rice, whole wheat, whole grain, barley, durum, sorghum, sunflower, canola, oats, flax, potatoes, buckwheat and combinations of any thereof (i.e., such as a multigrain product). Other food ingredient that may be used include, without limitation, food colorants, vitamins, minerals, edible oils or fats, emulsifiers, leavening agents, natural or artificial sweeteners, starches, thickening agents, fiber (including, but not limited to, a soluble fiber (i.e., FIBERSOL or INULIN) or an insoluble fiber), a cellulose (i.e., microcrystalline cellulose or carboxymethylcellulose), maltodextrins, corn-syrup solids, potato starch, corn starch, wheat starch, a vegetable product, a fruit product, a nut product or combinations of any thereof may be used.

### EXAMPLE I

In one embodiment, dehydrated legume products are prepared by the above processes wherein untreated thermally processed legumes are compared to ascorbic acid treated and gluconic acid treated legumes. The dehydrated legumes are reconstituted and the color of the finished products compared. These observations are shown in Table 1.

If any additional flavorings or ingredients, such as corn, soybean and sunflower oil, a whole grain product, wheat gluten, wheat protein isolate, salt, Mexican seasoning, ranch, dehydrated onion, peppers, tomato or cheese, nutritional additives and/or color are desired, they may be added at any one of three steps. These ingredients may be added during cooking, prior to dehydration or at the time of blending and packaging.

In another embodiment, wheat protein isolate may be used to bind particulate and/or powdered legume or bean flours together. The wheat protein isolate binder may comprise a modified wheat protein isolate alone or in combination with glycerin, a non-nutritive sweetener such as sorbitol, and water. In one embodiment, the wheat protein isolate comprises PROLITE brand wheat protein isolate available from Archer-Daniels-Midland Company of Decatur, Ill.

The legumes produced according to the methods described above are economical and well adapted to quick cooking. The bean powders are instantly reconstitutable with hot water. The beans may be used as quick cook beans or in bean dips, side or main dishes. Further, they may be incorporated into instant or quick cook soups, stews, breakfast cereals and snack foods.

### EXAMPLE II

In one embodiment, water is heated (i.e., boiled) and a dehydrated legume product is added to the heated water. The water and dehydrated legume product are stirred and the heat is removed. The resulting water and legume product are allowed to sit for a period of time (i.e., five minutes) and can be incorporated into a food product, mixed with other food ingredients, or used as a food stuff (i.e., refried beans).

### EXAMPLE III

In another embodiment, a taco or burrito filling includes the following components:

34% Beef

1.36% Taco seasoning

49.44% water

9.35% ADM Arcon T

0.85% ADM Arcon S

5% of a precooked bean powder.

The meat is ground to a size of about 1 inch, and re-ground to a size of about 0.25 inches. The Arcon T, Arcon S and precooked bean powder are added in a kettle with water. The mixture is cooked and allowed to hydrate for about 5-10 minutes. The meat and seasoning are added and mixed thoroughly, and the mixture is cooked at a temperature of about 170° F.

### EXAMPLE IV

A bean tortilla is prepared with Great Northern bean precooked powder and includes the following components:

300 g of ADM flour having 10.8-11.5% protein

293 g of water

22 g of ADM Arkady flour tortilla base

35 g of ADM tortilla shortening

75 g of precooked Great Northern bean powder

2 g of salt.

The dry ingredients are creamed with the shortening for 3-5 minutes at a low mixing speed. The water is added to the dough and mixed at a low mixing speed at a temperature of about 90-100° F. A 2 ounce ball is formed by scaling and allowed to rest for 15 minutes. The ball is pressed and cooked for 45-60 seconds.

### EXAMPLE V

Another tortilla is formed with the following components:

400 g of ADM flour having 10.8-11.5% protein

440 g of water

24 g of ADM Arkady Flour Tortilla base 6.0

50 g of ADM Tortilla shortening

16 g of Provim ESP gluten

160 g of precooked black bean powder

3 g of salt.

The dry ingredients and the shortening are creamed for 3-5 minutes on a low mixing speed. The water is added to the dough and mixed at a low speed at a temperature of 90-100° F. A 2 ounce ball is formed by scaling and allowed to rest for 15 minutes. The ball is pressed and cooked for 45-60 seconds.

### EXAMPLE VI

In another embodiment, a bagel is made with the following components:

600 g of high gluten flour

30 g of precooked black bean flakes

24 g of precooked black beans

6 g of ADM shortening

9 g of gluten

5 g of yeast

340 g of water

42 g of Arkady bagel base.

The precooked black bean flakes are soaked with 30 g of water for 5 minutes. The rest of the ingredients are added to the soaked black bean flakes and mixed at a first speed for 2 minutes, and at a second speed for 5 minutes. Bagels are formed from the batter and allowed to retard over night at 35-42° F. The batter is proofed in a relative humidity of 65-75% at a temperature of 86-95° F. The formed bagels are placed in boiling water for one minute on each side and baking for about 17 minutes at about 450° F.

Having described the present invention in some detail by way of illustration and example for purposes of clarity of understanding, it will be obvious to one of ordinary skill in the art that the same can be performed by modifying or changing the invention with a wide and equivalent range of conditions, formulations and other parameters thereof, and that such modifications or changes are intended to be encompassed within the scope of the appended claims.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

What is claimed is:

1. A composition comprising a legume product, wherein the legume product has an increased amount of dietary fiber on a dry weight basis as compared to a raw legume from which the legume product originates.

2. The composition of claim 1, wherein the legume product is selected from the group consisting of a powder, a flour, and combinations thereof.

3. The composition of claim 1, wherein the legume product has a particle size of 0.250 mm or less.

4. The composition of claim 1, wherein the composition has a form selected from the group consisting of a flake, a ribbon, and a combination thereof.

5. The composition of claim 1 further comprising an ingredient selected from the group consisting of water, wheat protein, wheat protein isolate, wheat gluten, buttermilk solids, milk powder, egg protein, canola protein, pea protein, potato protein, corn protein, sesame protein, sunflower protein, cottonseed protein, copra protein, palm kernel protein, safflower protein, linseed protein, peanut protein, lupin protein, oat protein, soy protein, soy protein concentrate, soy protein isolate, a flour, a meal, food colorants, vitamins, minerals, edible oils or fats, emulsifiers, leavening agents, natural or artificial sweeteners, starches, thickening agents, a soluble fiber, an insoluble fiber, a cellulose, maltodextrins, corn-syrup solids, potato starch, corn starch, wheat starch, a vegetable product, a fruit product, a nut product and combinations of any thereof.

6. The composition of claim 1, wherein the legume product comprises an intact legume.

7. The composition of claim 1, wherein the legume is selected from the group consisting of green peas, yellow peas, lentils, peanuts, chickpeas, trefoil, soybeans, pinto beans, Great Northern beans, navy beans, red beans, black beans, dark and light red kidney beans, fava beans, green baby lima beans, pink beans, myasi beans, black eyed beans, garbanzo beans, cranberry beans, white beans, rice beans, butter beans and combinations of any thereof.

8. A food product comprising the composition of claim 1, wherein the food product is selected from the group consisting of bean dips, taco fillings, taco shells, burrito fillings, tortillas, nacho components, soup bases, soups, taco salad components, refried beans, pasta, tortilla chips, chips, snack foods, milk, juice, soft drinks, tortillas, bagels, bread and dough.

9. A product produced by a process comprising:
blanching legumes or legume products;
cooking the legumes or legume products; and
dehydrating the legumes or legume products;
wherein blanching the legumes or legume products, cooking the legumes or legume products, or blanching the legumes or legume products and cooking the legumes or legume products occurs in the presence on an organic acid.

10. The product of claim 9, wherein the process further comprises breaking the legumes or legume products.

11. The product of claim 9, wherein the process further comprises decompressing the legumes or legume products.

12. The product of claim 9, wherein the legumes or legume products are beans.

13. The product of claim 9, wherein a dietary fiber content of the product is higher than the dietary fiber content of raw legumes.

14. The product of claim 10, wherein the process further comprises passing the broken legumes or legume products past a magnet.

15. The product of claim 9, wherein the process further comprises:
placing the legume or legume product in a container; and
shipping the legume or legume product.

16. A bean product having an increased amount of dietary fiber on a dry weight basis as compared to a raw bean from which the bean product originates.

17. The bean product of claim 16, wherein the bean product originates from a bean selected from the group consisting of pinto beans, Great Northern beans, navy beans, red beans, black beans, dark and light red kidney beans, fava beans, green baby lima beans, pink beans, myasi beans, black eyed beans, garbanzo beans, cranberry beans, white beans, rice beans, butter beans and combinations of any thereof.

18. The bean product of claim 16, wherein the bean product is selected from the group consisting of an intact bean, a powder, a flour, and a broken bean.

19. The bean product of claim 16, wherein a portion of the bean product has a particle size of less than 0.250 mm.

20. A foodstuff comprising the bean product of claim 16.
